(19) United States
(12) Patent Application Publication
(10) Pub. No.: US 2025/0208818 A1
(43) Pub. Date: Jun. 26, 2025

(54) SECURE REMOTE DESKTOP SESSION

(71) Applicant: Microsoft Technology Licensing, LLC, Redmond, WA (US)

(72) Inventors: Assaf BAR NESS, Rehovot (IL); Idan WOLF, Tel Mond (IL); Orr SROUR, Ramat HaSharon (IL)

(21) Appl. No.: 18/390,707

(22) Filed: Dec. 20, 2023

(51) Int. Cl. G06F 3/14; H04L 9/40; H04N 21/2347; H04N 21/845

(52) U.S. Cl. CPC G06F 3/1454; H04L 63/0435; H04L 63/061; H04N 21/2347; H04N 21/8456

(57) ABSTRACT

A method for securely providing a remote desktop session includes receiving, at a user device, an encrypted video stream that includes graphics content of the remote desktop session and that is characterized by a frame rate that is variable. The method further provides for reducing variability in the frame rate of the encrypted video stream by duplicating select encrypted frames of the video stream and inserting the duplicated encrypted frames into the video stream. The method additionally provides for delivering the video stream to a local application configured to generate control signals that cause a graphics processing unit (GPU) of the user machine to render the video stream to a display of the user machine.

### BACKGROUND

Digital Rights Management (DRM) encryption is a widely-adopted systematic approach to copyright protection for digital media and serves to prevent unauthorized redistribution of digital media and to restrict the way that consumers can copy video content. DRM encryption involves encoding video content in a way such that only authorized users can access it. Various DRM standards exist in the market that define protocols, algorithms, and hardware requirements governing the physical protection of consumer consumption of media content.

### SUMMARY

According to one implementation, a method for securely providing a remote desktop session comprises receiving an encrypted video stream at a user device that including graphics content of the remote desktop session. The encrypted video stream is characterized by a frame rate that is variable. The method further comprises reducing variability in the frame rate of the video stream at the user device by duplicating select encrypted frames of the video stream and inserting the duplicated encrypted frames into the video stream; and delivering the video stream to a local application configured to generate control signals that cause a graphics processing unit (GPU) of the user machine to render the video stream to a display of the user machine.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example system for providing a DRM-encrypted remote desktop session.

FIG. 2 illustrates an example system that uses a secure DRM encryption technique to protect remote desktop video content streamed from a remote display host machine to a user machine.

FIG. 3 illustrates example video segmentation and static frame generation operations of a remote-display protocol client.

FIG. 4 illustrates example operations for generating a DRM-encrypted remote desktop session by a remote desktop server.

FIG. 5 illustrates example operations for rendering DRM-encrypted video data of a remote desktop session on a user device.

FIG. 6 illustrates an example schematic of a processing device suitable for implementing aspects of the disclosed technology.

### DETAILED DESCRIPTION

In a typical DRM-encryption scenario, an online content provider encrypts a video stream using a symmetric key obtained from a DRM license server, segments and packages the stream to comply DRM standards, and then transmits the packaged encrypted stream to the user machine. When the user machine receives the video stream and a user tries to access the video, a DRM client on the user machine communicates with the DRM license server to authenticate the user and to obtain the appropriate symmetric key for decryption. If DRM-encryption is performed live (e.g., in response to a user streaming request), video encryption can introduce a significant lag between video request and video delivery. For this reason, encryption and packaging are often performed offline and in advance of the user's streaming request such that encrypted video files are maintained by the content provider and ready (e.g., at all times) to be transmitted in a variety of formats. However, this offline encryption and preparation in advance of a streaming request is not possible for live video. Using existing techniques, DRM encryption of a live video introduces 8-16 seconds of latency. For some applications of live video streaming, this significant latency is unacceptable.

The herein disclosed technology includes a low-latency methodology for utilizing DRM technology to create a secure remote desktop session. As used herein, the term “remote desktop session” is intended to refer to a compute session in which a user utilizes a personal device to interact with desktop graphics generated remotely. A remote desktop session could, for example, be a virtual desktop session hosted by a cloud-based server or a desktop session hosted by a user device that is remote to the user at the time of access, such as a desktop session of a physical computer at a business facility that an employee accesses from a remote location via an internet connection of another device. By example, virtual desktop infrastructure (VDI) is one form of computer virtualization that allows remote desktops to be hosted on remote servers. In VDI, each virtual desktop runs on a separate operating system and has its own resources such as one or more central computing units (CPUs) memory, and storage. Using VDI, remote access users can connect to their virtual desktops from any device with an internet connection. Remote Desktop Service (RDS) technology provides still other forms of computer virtualization that facilitates remote access. RDS technologies are like VDI but commonly provide for supporting multiple virtual desktops on a single cloud-hosted operating system. Both VDI and RDS are commonly used in business environments where employees need to access their personal or shared desktops from remote locations and/or on different devices. The herein disclosed technology is applicable to any service or technology that provides a virtual desktop experience by allowing a user to utilize a personal device to interact with desktop graphics generated remotely.

During a remote desktop session, graphics content of a desktop session is generated by a device (e.g., a cloud-based server) that is remote to the end user. This graphics content is stored in the form of frames (images of desktop graphics and different points in time) that are streamed, in series, to a user machine. The GPU on the user machine renders the graphics to the user display and updates the displayed frames at timing that correlates with timestamp data included in the metadata for each frame. During the remote desktop session, the user provides inputs (e.g., mouse and keyboard) to the remote desktop that are transported back to the virtual machine where they are processed to effect modifications (updates) the graphics shown within the virtual display. In this environment, the user essentially views and interacts with a video file. However, unlike traditional video streaming environments, low-latency is particularly important because it is essential that the user sees updated graphics in direct response to inputs that the user provides to the virtual desktop. If, for example, the user provides mouse input to drag an application window across the virtual desktop, it is desirable that the user see the window move immediately rather than several seconds later.

Currently-existing technologies do not provide a feasible solution for utilizing DRM encryption technology to protect the video content (e.g., virtual desktop graphics) that is streamed during remote desktop sessions. As mentioned above, current practices for DRM-encrypting live video introduce 8-16 seconds of lag time. In the context of a VDI or RDS session, this would mean that the user could provide keyboard or touch input to the virtual desktop and not see any moments or alterations of the screen for 8-16 seconds afterward. This enormous lag time would render remote desktop technology unworkable.

Moreover, even assuming the large latencies were not problematic, the use of current DRM-encryption methods to encrypt a remote desktop session would also result in a playback stream characterized by a high level of instability—e.g., a high susceptibility to hanging and/or causing a crash of the application being used to play the content. This high level of instability arises from the fact that remote desktop session content is streamed at a variable frame rate. In contrast to typical digital media content that is characterized by a constant frame rate, remote desktop sessions have a highly variable frame rate since the presented frame may only be updated in response to changes in the graphics content of the remote desktop. If, for example, the graphics on the remote desktop remains static for a five second interval (e.g., a document image is displayed but the user is not actively providing any inputs), the cloud server hosting the remote desktop session may not send a single new frame throughout this entire static interval.

The above-described high frame rate variability of remote desktop video data creates problems during decryption because a DRM client on the user machine is designed to process video that is of constant frame rate. When a DRM client receives a video stream characterized by a variable frame rate, the application behaves in an instable manner and is therefore likely to hang or crash. Currently-existing DRM applications are therefore not equipped to process variable-framerate video data of the type that is streamed during remote desktop sessions.

The herein disclosed technology provides a technique for securely encrypting a remote session using DRM-encryption technology while realizing much lower latencies than those resulting from standard encryption practices and while also guaranteeing the user a stable video-viewing experience even though the VDI video has a variable frame rate.

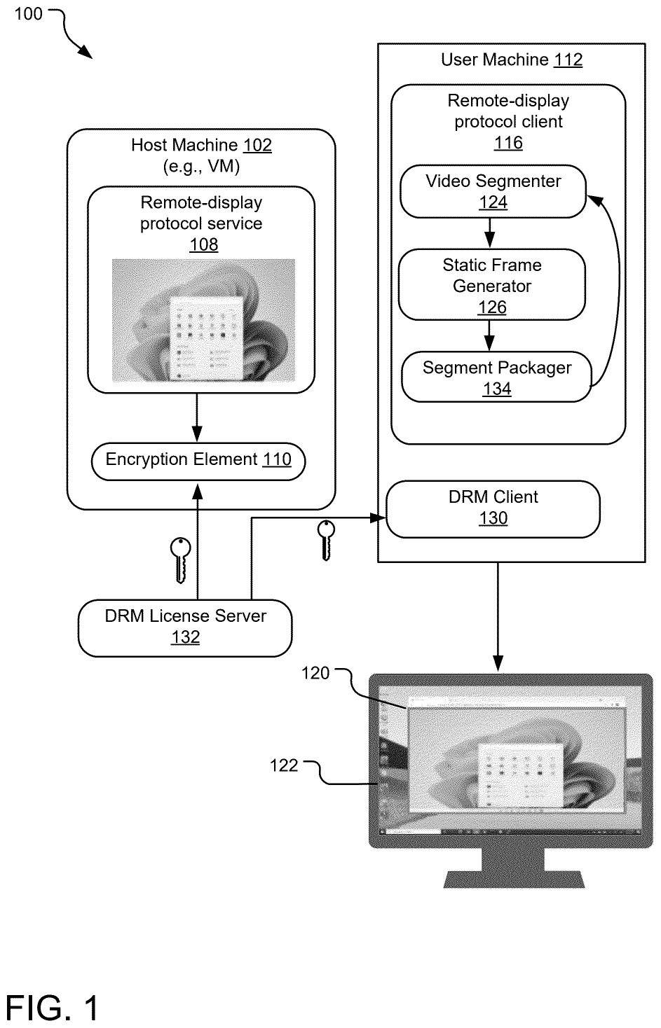

FIG. 1 illustrates an example system 100 for providing a DRM-encrypted remote desktop session. The system includes a host machine 102 that hosts the remote desktop session and a user machine 112 that is used to access the remote desktop session. In various implementations of the technology, the host machine 102 assumes different forms. In one implementation, the host machine 102 is a virtual machine hosted by a cloud server. In other implementations, however, the host machine 102 is a user-operated device (e.g., not at a data center) that is configured to provide a remote session. For example, the host machine 102 is a physical computer on premise at a company facility that an employee of the company can access from elsewhere in the same facility and/or other locations around the world via an internet connection and a remote desktop interface.

The host machine 102 executes software referred to herein as a remote-display protocol service 108 which can be understood as software that facilitates remote access to applications and data over a network using a remote-display protocol. The most common remote-display protocol is the Remote Desktop (RDP) protocol. However, other protocols include Independent Computing Architecture (ICA) and virtual network computing (VNC). As used herein, the term “remote-display protocol” refers to any suitable protocol for providing access to a virtual desktop including RDP, ICA, VNC, etc. The acronym “RDP” is, in contrast, used to refer to the standardized RDP protocol.

In implementations where the host machine 102 is a virtual machine, the virtual machine includes hardware resources partitioned from a cloud server (e.g., one or more central processing units (CPUs), memory, and storage) with network access via a network interface controller (NIC) of the cloud server. The virtual machine hardware executes software including an operating system, applications, and settings that collectively generate graphics of a remote desktop and that provide functionality of a personal computer.

In one implementation where the host machine 102 is a VM hosted by a cloud server (not shown), the cloud server supports multiple different virtual machines configured similar to the host machine 102, each of which is configured to provide remote desktop functionality for a different end user. For example, the remote-display protocol service 108 is configured to support a VDI session that virtualizes a user's desktop environment by providing a dedicated operating system to the user, with the operating system being configured to execute the user's desktop applications and implement the user's settings. In other implementations, the host machine 102 is a VM that runs a single operating system that supports remote desktop sessions for several users. For example, the remote-display protocol service 108 is configured to isolate and manage many concurrent RDS sessions on behalf of different users.

In one implementation, a user initiates a remote desktop session (e.g., a VDI session, RDS session, or the like) by launching a remote-display protocol client 116 on the user machine 112 and by providing inputs, such as account credentials, to access a designated and previously-configured remote compute environment. The remote-display protocol client 116 opens a connection to the remote-display protocol service 108 on the host machine 102 and also sends control signals to a GPU 118 of the user machine 112 to open an application window 120 on a display 122 of the user machine 112. Once the remote session has been established, the application window 120 is populated with graphical content that is generated at the host machine 102 and streamed to the user machine 112 by the remote-display protocol service 108. Notably, the display 122 of the user machine 112 external to the application window 120 is populated with locally-generated graphics while the application window 120 is presenting a remotely-generated desktop with graphics generated by executable components of the host machine 102.

Notably, the illustrated scenario is one in which the remote desktop content is generated by the applications and operating system of host machine 102 (e.g., a VM) and translated by a GPU of the host machine 102 into a digital image that changes over time, such as in response to user inputs provided to the remote desktop as well as in response to operations of the local applications and operating system. Image data generated by the GPU of the host machine 102 is recorded by the remote-display protocol service 108 as a series of digital frames that are sent to the user machine 112 in the form of a video stream. In one implementation, the remote-display protocol service 108 records and sends frames of the remote desktop in accordance with a variable frame rate that is, on average, much lower than traditional digital media frame rates because no frames are sent while the image on the screen remains static. For example, a traditional digital media frame rate may provide for 30 frames per second even during times when the display image remains unaltered for one or several seconds. In contrast, the frame rate of the remote desktop session is zero during time intervals when the displayed image remains unaltered.

In one implementation, the remote-display protocol service 108 records and transmits a new frame each time there is an alteration to the graphics content of the remote display; however, no new frames are sent during intervals when the graphics content remains static.

In typical applications of DRM-encryption on live video content, a video stream is encrypted in small segments, for example, in frame segments that span eight or so seconds of playback time. Each segment of frames is encrypted and packaged by the content provider according to a protocol compatible with the user's machine, such as the MPEG-DASH protocol, the HTTP Live Streaming (HLS) protocol, or the Smooth Streaming protocol. As mentioned elsewhere herein, encryption of live video introduces substantial latency that is, on average, at least as long as the segment length. If, for example, the encrypted segment length is 8 seconds, then the segment is recorded as it happens for eight seconds, encrypted, transmitted, and decrypted by the user machine. Here, the user does not view the first second of the eight second clip until the full eight seconds has elapsed in addition to encryption, transmission, and decryption time that is added on to those eight seconds.

Per existing DRM-encryption methodologies for live video, longer segments (e.g., 8 seconds) are chosen to ensure stability of the outgoing video stream. If a content server is overloaded with high numbers of small requests such as by being asked to perform an encryption task 30 times per second (e.g., on each of 30 frames generated each second), this can cause the server to behave in an unstable manner, such as by hanging due to experiencing errors. However, in the case of remote desktop streaming, the much lower average frame rate makes it possible to individually encrypt much smaller video segments without overloading the CPU of the machine performing the encryption. In one implementation of the disclosed technology, the remote-display protocol service 108 encrypts each individual frame separately. The frame is transmitted to the user machine 112 as soon as it is encrypted; consequently, the user machine 112 receives and renders the frame less than 100 milliseconds after the timestamp at which the frame was captured.

In the system 100, the host machine 102 includes an encryption element 110, which consists of software or a combination of software and hardware configured to perform DRM-encryption operations on behalf of the remote desktop session. When the remote desktop session is initiated, the remote-display protocol service 108 obtains information from the user machine 112 that includes, or that can be used to identify, one or more DRM encryption and/or encoding schemes that are supported by the DRM client 130 executing on the user machine 112. The remote-display protocol service 108 provides this information to the encryption element 110, and the encryption element 110 requests and acquires a symmetric content encryption key (CEK), also referred to herein as the “symmetric key,” from the DRM license server 132 that is to be used to encrypt the video frames of the remote desktop session.

While the remote desktop session is live, the remote-display protocol service 108 provides each video frame of the remote session to the encryption element 110, and the encryption element 110 uses the symmetric key to encrypt the video frames according to a select DRM encryption scheme that is among those supported by the DRM client 130 executing on the user machine 112. In one implementation, the encryption element 110 encrypts each individual video frame independent of all other video frames of the remote desktop session. In addition to encrypting the remote desktop video content, the encryption element 110 also encodes the video frames according to specific codecs that are known to and expected by the DRM client 130 on the user machine 112. In some implementations, the encryption element 110 uses a hardware accelerator to perform the encoding operations.

In contrast to traditional DRM-encryption practices where the content provider performs both encryption and packaging, the herein disclosed technology provides for sharing the load of the DRM encryption and video packaging between the host machine 102 and the user machine 112 in a way that allows for a reduction in overall latency. Specifically, frame encryption is performed by the host machine 102 (as described above), while video segmentation and packaging operations are delegated to the remote-display protocol client 116 of the user machine 112.

When the remote-display protocol client 116 begins receiving the encrypted video frames of the remote desktop session, the frames are provided to a video segmentor 124. The video segmentor 124 groups the incoming encrypted video frames into segments of a predefined temporal length, and each segment includes frames with timestamps corresponding to a discrete interval of the predefined temporal length. In one implementation, each segment includes video data spanning less than 100 total milliseconds. For example, the video segmentor 124 is configured to group the sequential frames into segments that span 90 total milliseconds, which each segment being fully consecutive to and sequential with the prior segment such that a first segment includes video frames with timestamps corresponding to the interval spanning the first 0-90 milliseconds (ms) of remote desktop session, a second segment includes video frames with timestamps corresponding to a 90 millisecond interval following the first interval (e.g., 91-180 ms), a third segment including video frames with timestamps corresponding to the next 90 millisecond interval (e.g., 181-270 ms) immediately following the second interval, and so on.

Since the remote desktop video stream is characterized by a variable frame rate, the different segments (corresponding to equal-length time intervals) may initially include different numbers of video frames. Each segment of encrypted video frames is provided to a static frame generator 126 that is configured to reduce variability in the frame rate of the corresponding segment by creating and selectively inserting duplicate frames. In one implementation, the static frame generator 126 is configured to selectively add duplicate frames to each segment as necessary to transform the variable frame rate of the segment into a static, predefined frame rate, such as a frame rate that is comparable to traditional forms of digital video and also compatible with the DRM client 130 on the user machine 112.

In another implementation, the static frame generator 126 is configured to reduce variability of the frame rate by creating duplicate frames to smooth frame rate variability according to a methodology that does not eliminate all variability in the frame rate. For example, if the DRM client 130 is tolerant of a small degree of frame rate variability, the static frame generator 126 may reduce the frame rate variability to within the accepted level of tolerance.

The benefit of selectively inserting the duplicate (e.g., static) frames is two-fold: first, the elimination or substantial reduction of frame rate variability ensures that the video segments can be processed and rendered on the user machine 112 without crashing the DRM client 130. This is because, as mentioned above, the DRM client 130 may be specifically designed to support videos that have a static frame rate or nearly-static frame rate. Additionally, creating the static frames at the content destination (as opposed to the content source) serves to ensure that the video stream can be transmitted with the low latency (e.g., <100 ms between capture and rendering) and high stability. As mentioned elsewhere herein, stream stability may be threatened in scenarios where the content source (e.g., the host machine 102) is overwhelmed by high numbers of very small processing requests, such as requests to separately encrypt each one of 30 frames per second. Offloading the creation of the duplicate frames to the user machine ensures that the host machine 102 will not suffer performance degradation as a result of encryption operations requested at a high frequency.

Moreover, the amount of processing overhead consumed while generating a duplicate encrypted frame is considerably lower than the amount of processing overhead consumed during encryption of an unencrypted frame. Thus, in contrast to performing frame encryption of individual frames at a high frame rate (e.g., 30 frames per second), the duplication of high numbers of already-created encrypted frames does not pose a risk of overwhelming the CPU on the user machine 112. Further still, network bandwidth is conserved by creating the duplicate frames at the destination because this drastically reduces the number of video frames transmitted between the content source and viewing destination.

After the static frame generator 126 creates the duplicate frames to reduce or eliminate variability in the frame rate, the segments are provided to a segment packager 134. The segment packager 134 packs the segments according to a format expected by the DRM client 130. For example, the DRM client 130 may expect that the incoming video packets be packed into a container certain header information. In one implementation, the video packager packs each received of the received segments into an MP4 container containing a special header that states the encryption scheme and the DRM license server address. The segment packager 134 provides the segmented, packaged, encrypted video segments to the DRM client 130 on the user machine 112. Performing the segmenting and packaging of the video stream on the user machine 112 allows for the frames to be encrypted and transmitted individually, rather than as encrypted packaged segments of video file. This leads to the above-described reductions in latency-mainly, encryption and transmission can be performed immediately (e.g., without having to wait for several seconds of data to be encrypted, packaged, and transmitted). Consequently, the remote-display protocol client 116 can begin receiving data much more quickly than in implementations where the data is packaged into larger multi-second segments (e.g., eight-second segments).

In one implementation consistent with traditional DRM key-exchange procedures, the DRM client 130 acquires the DRM license server address from the header of the packaged frames and communicates with the DRM license server 132 to obtain a copy of the symmetric key that was used to encrypt the video stream. For example, DRM client 130 authenticates itself to the DRM license server 132 (e.g., by presenting a certificate) along with a public key of the user machine 112, and the DRM license server 132 uses the public key of the user machine 112 to encrypt a rights object (RO) that includes the symmetric key. The encrypted RO is sent to the user machine 112, and the DRM client 130 uses a device private key of the user machine to access the symmetric key and, in turn, to provide the symmetric key to a decoder (not shown) in the user machine 112. The DRM client 130 generates GPU control signals that cause the content to be decrypted and rendered in the decoder of the user machine 112. The content is ultimately presented in the application window 120.

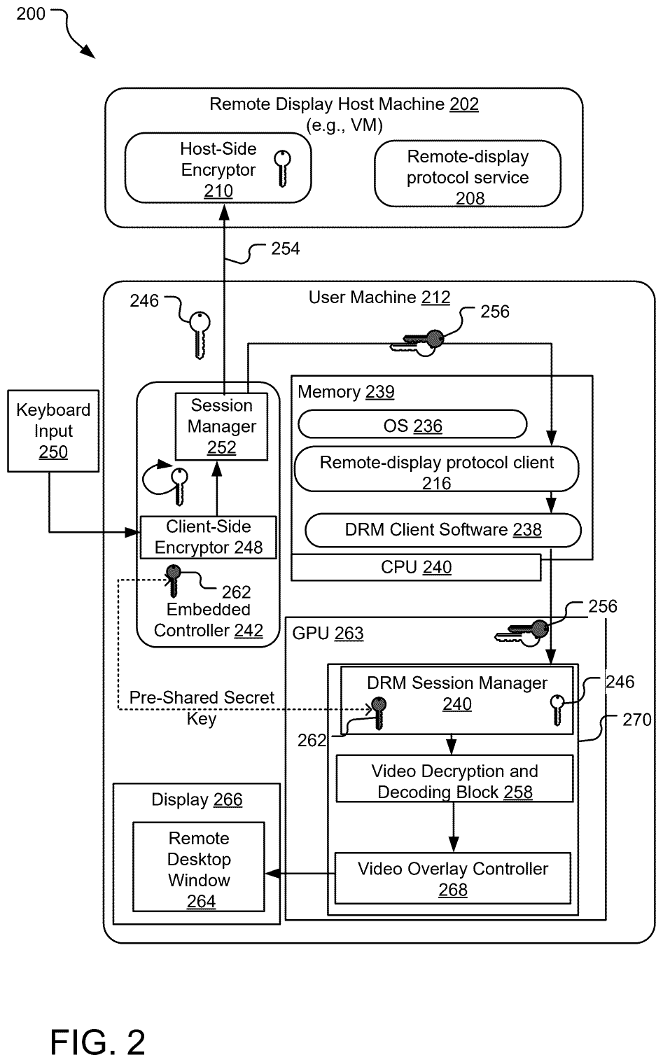

In another implementation, the exchange of the symmetric content encryption key does not entail a third-party key management authority (e.g., the DRM license server 132), and the symmetric key is generated on the user machine 112 and provided to the remote display host machine 202 in response to initiation of a new remote desktop session. FIG. 2 illustrates a detailed example of this alternative approach to key management with added security measures to ensure that the video stream of the remote desktop session remains secure even if the user machine 112 has been compromised, such as due to the installation of malware on the operating system.

FIG. 2 illustrates an example system 200 that uses a secure DRM encryption technique to protect remote desktop video content streamed from a remote display host machine 202 (e.g., a virtual machine providing a remote desktop experience) to a user machine 212. In the illustrated system, the remote display host machine 202 executes remote-display protocol service 208 (e.g., an RDP server) that generates a remote desktop in the form of video frames that are streamed, as a sequence of encrypted video frames, to the user machine 212. The video frames are decrypted on the user machine 212 and ultimately presented in an application window of a remote-display protocol client 216 executing on the user machine 212.

The remote-display protocol client 216 is an application installed on an operating system 236 that includes components and features the same or similar to the remote-display protocol client 116 described with respect to FIG. 1. The OS 236 and the remote-display protocol client 216 are stored in memory 239 and executed by a central processing system (CPU) 240 of the user machine 212. The user machine 212 also includes a hardware-based DRM client that includes both software components (shown as DRM client software 238) and hardware components 270, including a DRM session manager 240, a video decryption and decoding block 258, and a video overlay controller 268).

The system 200 differs from that shown and described with respect to FIG. 1 in the implementation of symmetric key management. Per this approach, a symmetric key 246 (used for both encryption and description) is generated at an embedded controller (EC) 242 of the user machine 212 while the EC 242 is operating in a secure mode that isolates its data from the OS 236. The EC 242 can be understood as comprising hardware or a combination of hardware and software (e.g., firmware) including a microprocessor that implements control logic for receiving and processing keyboard and mouse inputs. In some implementations, the EC 242 is tasked with other operations including management of keyboard backlighting and/or handling user inputs supplied by other types of input accessories—e.g., trackpad, stylus, touchscreen, etc.

The EC 242 includes a client-side encryptor 248 configured to selectively encrypt keyboard input 250 and/or other locally-generally data when operating in a secure mode. In one implementation, the user provides device inputs (e.g., a keystroke such as a keyboard key combination) to instruct the EC 242 to enter a secure mode. In another implementation, the EC 242 enters the secure mode in response to a device-internal signal indicating that the user has initiated a remote desktop session. For example, the device-internal signal is generated by the remote-display protocol client 216 in response to user inputs received through a user interface of the application. Upon entering the secure mode, communication channels are disabled between the EC 242 and the OS 236, leaving the EC 242 isolated from the OS 236 and its applications.

When operating in the secure mode, the client-side encryptor 248 of the EC 242 generates the symmetric key 246, and this key may be re-generated each time the secure mode is re-entered. A session manager 252 (e.g., firmware executing on the microprocessor of the EC 242) establishes a secure output channel 254 to a host-side encryptor 210 of the remote display host machine 202. The secure output channel 254 bypasses the OS 236 in the sense that the OS 236 does not have access to any data traveling along the secure output channel 254. The use of this secure output channel 254 reduces the likelihood of unauthorized access to the data (e.g., by a nefarious actor that has acquired access to the operating system such as via installation of malware). In some implementations, the data traveling along the secure output channel 254 is subject to additional levels of encryption and decryption that are, for example, applied by third-party servers not shown in FIG. 2. The symmetric key 246 is sent to the host-side encryptor 210 of the remote display host machine 202 (e.g., the VM) along the secure output channel 254.

Consistent with the description of the system 100 in FIG. 1, the host-side encryptor 210 uses the symmetric key 246 to encrypt the video stream of the remote desktop session streamed to the user machine 212. This encryption is, in one implementation, performed on an individual frame basis in the sense that each video frame is encrypted using the symmetric key 246 independent of the encryption of any other frame in the video stream.

In the illustrated implementation, the EC 242 uses a secret device key 260 to encrypt the symmetric key 246, yielding an encrypted symmetric key 256, which is shared with the remote-display protocol client 216, such as in response to generation of the symmetric key 246 or another trigger event. Notably, the secret device key 260 is a key that is not known to the OS 236 or to any of the applications executing on the OS 236. In one implementation, the secret device key 260 is a key provisioned during device manufacturing and is shared (e.g., during device manufacturing or provisioning) with a GPU 263 of the user machine 212, such that a DRM session manager 240 (e.g., DRM hardware components) has access to the secret device key 260 throughout the lifetime of the user machine 212. Encryption of the symmetric key 246 with the secret device key 260 allows for passage of the symmetric key, without interception, through the OS 236 and to the GPU hardware tasked with decrypting the remote video session.

Upon receipt, the remote-display protocol client 216 provides the encrypted symmetric key 256 to the DRM client software 238 and the DRM client software 238, in turn, shares the encrypted symmetric key 256 with the DRM session manager 240 residing within the GPU 263. Since the GPU 263 also stores the pre-shared secret device key 262, the DRM session manager 240 is able to use the secret device key 262 to extract the symmetric key 246 from the encrypted symmetric key 256 and to provide the symmetric key 246 to the video decryption and decoding block 258 which, in turn, decrypts and decodes the segmented, packaged video frames that it receives from the DRM client software 238. The decrypted, decoded video frames are then passed to the overlay controller 268 that renders the data to a remote desktop window 264 of the remote-display protocol client 216 presented on a display 266 of the user machine 212.

Since the OS 236 lacks access to the symmetric key 246 used to encrypt the remote desktop session, the video frames of the remote desktop session are not readable by the OS 236 or any individual that has nefarious acquired access to the OS data. Consequently, the remote desktop session remains secure even if malware installed on the OS 236 has provided a hacker with access to the OS 236, all applications executing on the OS 326, and all respective data of the OS 236 and those applications. If, for example, malware is installed on the OS 236, a nefarious actor may be able to view all data rendered to the display outside of the remote desktop window 264 (e.g., icon and data generated by the OS 236 and applications executing on the OS 236). However, due to the encryption of the remote session desktop data per the above-described methodology, this nefarious actor would not see any data within the remote desktop window 264. For example, the remote desktop window 264 may appear as a solid black on the display of the nefarious actor's device.

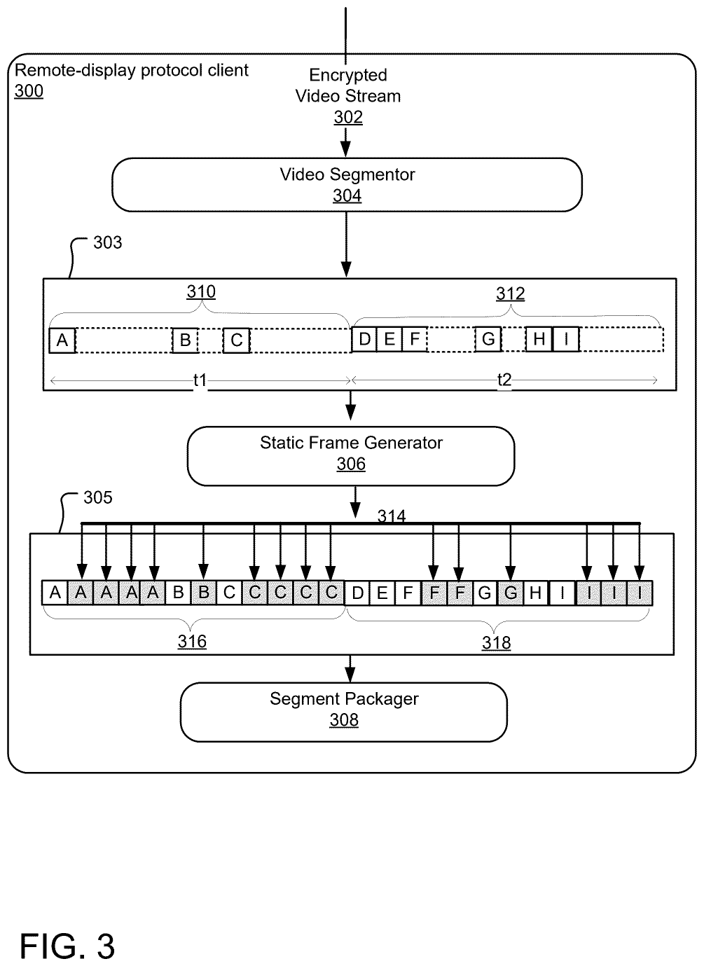

FIG. 3 illustrates example video segmentation and static frame generation operations of a remote-display protocol client 300 that executes on a user machine and that interacts with a remote host to provide a remote desktop session to a user. The remote-display protocol client 300 includes software components the same or similar to those described with respect to FIG. 1 including a video segmentor 304, a static frame generator 306, and a segment packager 308. During a remote desktop session, the video segmentor 304 receives an encrypted video stream 302 from the session host. The video segmentor 304 creates segments of video by grouping together consecutively-received frames that correspond to discrete time intervals (e.g., t1, t2, which are presumed to be of equal length). By example, view 303 illustrates two segments 310 and 312 of video data output by the video segmentor 304. The segments are labeled with alphabetical letters with alphabetical order corresponding to a sequential order of the frame timestamps. Each video frame in the encrypted video stream 302 has a timestamp; however, the encrypted video stream 302 is characterized by a variable frame rate so there exists a variable separation between the timestamps of pairs of consecutively-received frames (e.g., A to B, B to C, C to D). The unequal spacing between pairs of the video frames within the segments 310 and 312 is intended to indicate relative temporal separations between the timestamps of the illustrates frames. In one implementation, the remote session host sends a new video frame in response to each update to the graphics of the remote desktop. No video frames are sent during time intervals where the remote desktop remains static.

The video segments 310, 312 of variable frame rate are input to a static frame generator 306 that selectively inserts duplicate encrypted frames 314 (e.g., shown in gray shading) to each segment 310, 312 as necessary to transform the initially-variable frame rate of the segment into a static, predefined frame rate. A view 305 illustrates constant frame rate segments 316 and 318 that are output by the static frame generator 306. Each of the constant frame rate segments 316 and 138 has a temporal length identical to the corresponding input segment 310 or 312 (which are presumed to be equal in length to one another).

Notably, some implementations may position the static frame generator 306 upstream of the video segmentor 304 (e.g., in the reverse order of that shown in FIG. 3), as the segments can be created either before or after the insertion of the duplicate (static) frames. The constant frame rate segments 316 and 318 are input to a segment packager 308, which packs each segment into a container format expected by a local DRM client (e.g., an MP4 container) and that adds various header protocol information consistent with the information expected by the DRM client.

The frame rate smoothing illustrated by FIG. 3 allows the encrypted segments of the encrypted video stream 302 to be processed without error by the DRM client. Moreover, the generation of the duplicate encrypted frames 314 on the user machine (e.g., the device being used to view the video stream) substantially decreases network bandwidth consumed by the transmission of the encrypted video stream to the user machine.

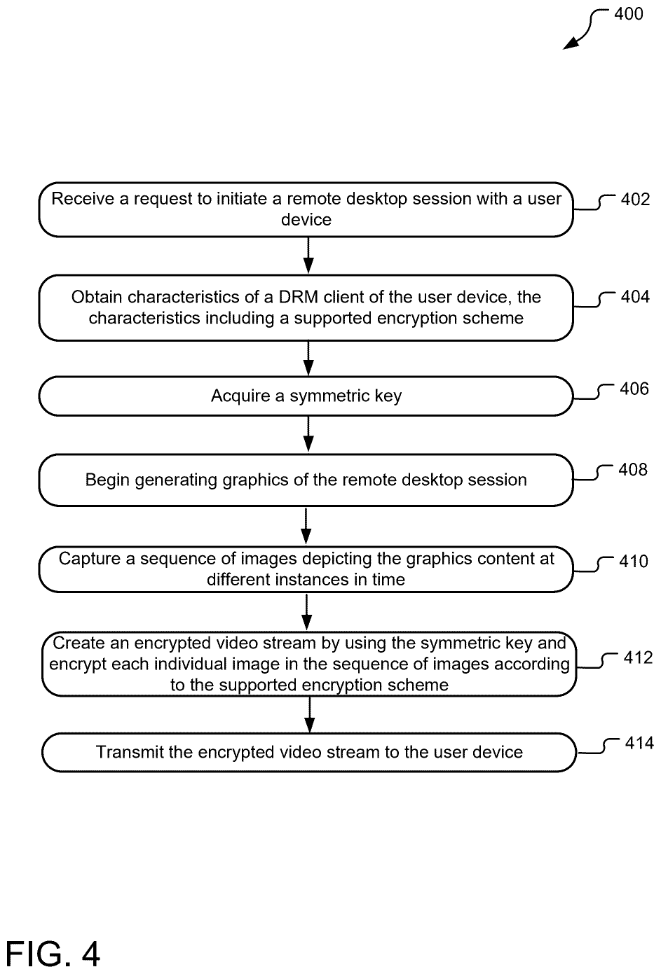

FIG. 4 illustrates example operations 400 for generating a DRM-encrypted remote desktop session by a remote desktop server. In one implementation, the remote desktop server executes a virtual machine that executes a remote-protocol display service. For example, the virtual machine is configured as an RDP server that serves content of a VDI session to remote user interacting with a user device. The operations 400 include a receiving operation that receives a request to initiate a remote desktop session with the user device of the remote user. A communication operation 404 obtains characteristics of a DRM client on the user device. For example, the remote-protocol display service communicates with a remote-display protocol client on the user machine to discover the identity of the DRM client and characteristics of the DRM client such as encryption scheme(s) (e.g., algorithms) supported by the DRM client and codecs that the DRM client has access to for decoding received data.

A key acquisition operation 406 acquires a symmetric key to be used for encrypting data of the remote desktop session. In one implementation, the remote desktop server obtains the symmetric key from a third-party DRM license server (e.g., consistent with the security scheme described herein with respect to FIG. 1). In another implementation, the remote desktop server obtains the symmetric key from the user device itself (e.g., consistent with the security scheme described with respect to FIG. 2). For example, the user device may include a software or hardware element that is instructed or controlled to generate the key in response to user initiation of the remote desktop session. In one implementation, the symmetric key is generated by an embedded controller of the user device and sent to the remote desktop server while the embedded controller of the user device is operating in a secure mode that disables communication channels on the user device between the embedded controller and the local operating system.

Following acquisition of the symmetric key and the characteristics of the DRM client on the user device, a graphics generation operation 408 begins generating graphics of the remote desktop session. An image capture operation 410 captures a sequence of images that each depict the graphics content at a different instance in time, and an encryption operation 412 creates an encrypted video stream by using the symmetric key to encrypt each individual frame in the sequence of images independent of every other image in the sequence and according to the encryption scheme supported by the DRM client on the user device. In some implementations, the operations further include encoding the video stream (either before or after encryption) according to an encoding scheme that is supported by the DRM client on the user device.

In one implementation where the DRM client supports decryption according to multiple encryption/decryption schemes (algorithms), the encryption operation 412 entails adding information to the encrypted video stream that identifies the select encryption scheme used to generate the encrypted frames. For example, each frame may be appended with a header that identifies the encryption scheme used to encrypt the data within the frame. Likewise, in implementations that supported video encoding on the remote desktop server, the encrypted video stream may be appended with information identifying the codec(s) used to perform the encoding.

A transmission operation 414 transmits the encrypted video stream to the user machine. In one implementation, the encrypted frames are transmitted without being segmented or packaged for receipt by the DRM client of the user machine. For example, the frames are not packed into containers of a particular format and are received at the user device as a series of individual encrypted video frames. In one implementation, the encrypted frames are delivered as IMSC1 (Internet Media Subtitles and Captions)-compatible TTML (timed text markup language) frames.

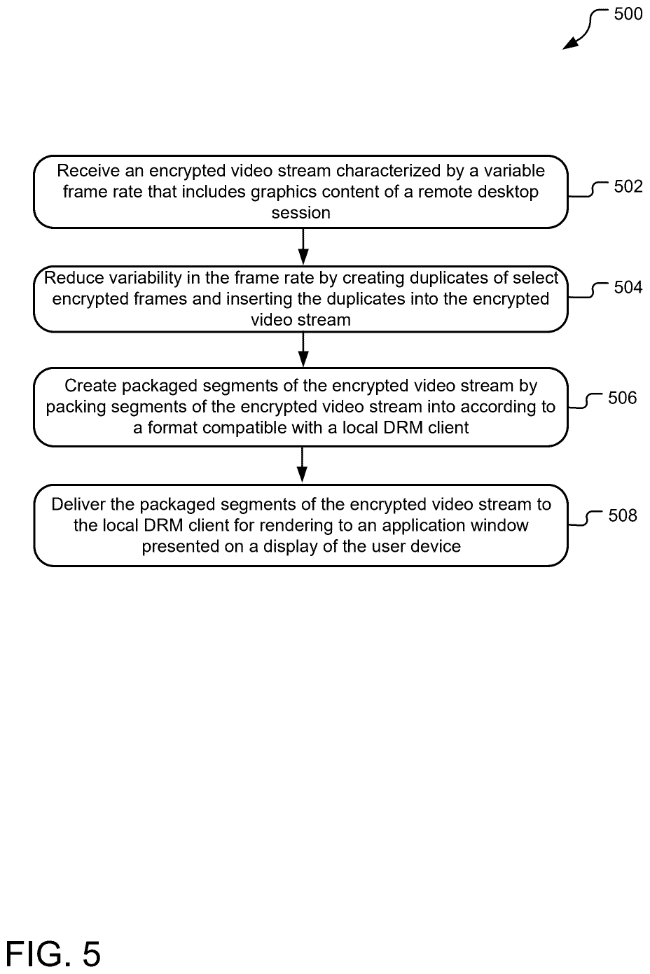

FIG. 5 illustrates example operations 500 for rendering DRM-encrypted video data of a remote desktop session on a user device. In one implementation, the operations 500 are performed by the user device following or in response to the operations described above with respect to FIG. 4. A receive operation 502 receives an encrypted video stream that includes graphics content of a remote desktop session. In one implementation, the encrypted video stream includes a series of ungrouped (unsegmented) encrypted frames and is characterized by a variable frame rate. A frame duplication operation 504 reduces variability in the frame rate by duplicating select frames of the encrypted video stream and by inserting the duplicate encrypted frames of the encrypted video stream at corresponding locations (e.g., immediately following the original frame that was duplicated), such as according to the example operations illustrated herein with respect to FIG. 3. A segmenting and packaging operation 506 creates packaged segments of the encrypted video stream according to a format compatible with a local DRM client of the user device. In one implementation, the segmenting and packaging operation 506 creates short segments of the encrypted frames, with each segment being of equal temporal length and associated with a different consecutive time interval. In one implementation, the segments within each group span have timestamps corresponding to a time interval that is less than 1 second long. For example, the segment length is less than 100 ms. Following packaging and insertion of the duplicate frames, the segments are packaged according to a format expected by the local DRM client. For example, the segments are wrapped into an MP4 containers and formatted according to a select protocol such as DASH (dynamic adaptive streaming over HTTP), HLS (HTTP Live Streaming)/CMAF (Common Media Application Format), or chunked WebVTT (Web Video Text Tracks Format) for HLS/TS (Transport Stream) protocols.

A delivery operation 508 delivers the packaged segments of the encrypted video stream to the local DRM client for rendering to an application window presented on a display of the user device.

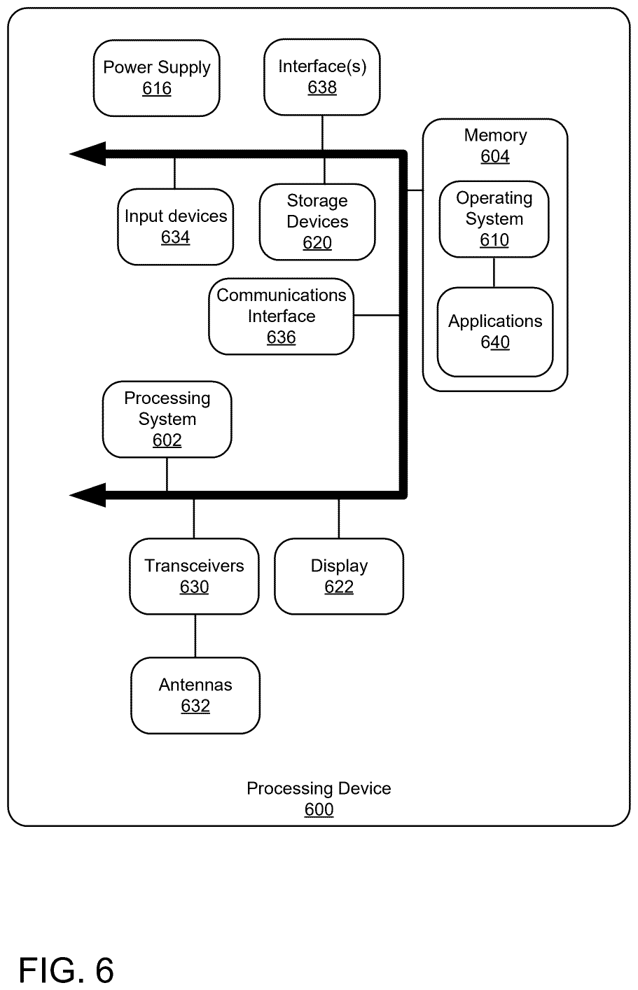

FIG. 6 illustrates an example schematic of a processing device 600 suitable for implementing aspects of the disclosed technology. The processing device 600 includes a processing system 602, memory 604, a display 622, and various input and/or output interfaces 638 (e.g., buttons). The processing system 602 may each include one or more central processing units (CPUs), graphics processing units (GPUs), etc. The memory 604 generally includes both volatile memory (e.g., random access memory (RAM)) and non-volatile memory (e.g., flash memory). An operating system 610, such as the Microsoft Windows® operating system or other operating system resides in the memory 604 and is executed by the processing system 602.

One or more applications 640 (e.g., the remote-display protocol client 116 of FIG. 1, software elements of the DRM client 130 of FIG. 1, software elements of the encryption element 110 of FIG. 1, the remote-display protocol service 108 of FIG. 1) are loaded in the memory 604 and executed on the operating system 610 by the processing system 602. The applications 640 may receive inputs from one another as well as from various input local devices 634 such as a microphone, input accessory (e.g., keypad, mouse, stylus, touchpad, gamepad, racing wheel, joystick), and a camera.

Additionally, the applications 640 may receive input from one or more remote devices, such as remotely located servers or smart devices, by communicating with such devices over a wired or wireless network using more communication transceivers 630 and an antenna 632 to provide network connectivity (e.g., a mobile phone network, Wi-Fi®, Bluetooth®). The processing device 600 also includes storage (e.g., non-volatile storage) for battery charge profile data, logic for executing remedial actions based on the battery charge profile data, and more.

The processing device 600 further includes a power supply 617, which is powered by one or more batteries or other power sources, and which provides power to other components of the processing device 600. The power supply 616 may also be connected to an external power source (not shown) that overrides or recharges the built-in batteries or other power sources. Additionally, the processing device 600 includes a communications interface 636 for communicating with other processing devices across a network, such as a local area network (LAN) and/or a wide area network (WAN) (e.g., the internet).

The processing device 600 may include a variety of tangible computer-readable storage media and intangible computer-readable communication signals. Tangible computer-readable storage can be embodied by any available media that can be accessed by the processing device 600 and includes both volatile and nonvolatile storage media, removable and non-removable storage media. Tangible computer-readable storage media excludes intangible and transitory communications signals and includes volatile and nonvolatile, removable, and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 600. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

In some aspects, the techniques described herein relate to a method for securely providing a remote desktop session including: at a user machine, receiving a video stream including graphics content of the remote desktop session, the video stream being encrypted and characterized by a frame rate that is variable; at the user machine, reducing variability in the frame rate of the video stream by duplicating select encrypted frames of the video stream and inserting the duplicated encrypted frames into the video stream; and delivering the video stream to a local application configured to generate control signals that cause a graphics processing unit (GPU) of the user machine to render the video stream to a display of the user machine.

In some aspects, the techniques described herein relate to a method, wherein each frame of the video stream that is received at the user machine has been encrypted individually.

In some aspects, the techniques described herein relate to a method, further including: at the user machine, segmenting the encrypted frames into groups and packaging the groups as individual containers, each of the individual containers including a sequence of frames that spans a playback period of less than one second.

In some aspects, the techniques described herein relate to a method, wherein the local application is a digital rights management (DRM) client and the method further includes: determining a format of encrypted data expected by the DRM client; and at the user machine, segmenting and packaging the video stream according to the format expected by the DRM client.

In some aspects, the techniques described herein relate to a method, wherein reducing variability in the frame rate entails eliminating variability in the frame rate.

In some aspects, the techniques described herein relate to a method, further including: generating a symmetric key at an embedded controller of the user machine; based at least in part on user initiation of the remote desktop session: transmitting the symmetric key to a remote server hosting the remote desktop session; generating an encrypted symmetric key by locally encrypting the symmetric key with a private device key pre-shared between the embedded controller and a GPU of the user machine; and sharing the encrypted symmetric key with a DRM client installed on the user machine.

In some aspects, the techniques described herein relate to a method, wherein the embedded controller transmits the symmetric key to the remote server along a secure channel that is not accessible to an operating system of the user machine.

In some aspects, the techniques described herein relate to a method, further including: within the GPU of the user machine, using the private device key to retrieve the symmetric key from the encrypted symmetric key; and decrypting the encrypted frames using the symmetric key.

In some aspects, the techniques described herein relate to a system for securely providing a remote desktop session, the system including: a remote-display protocol client stored in memory of a user machine that: receives a video stream including graphics content of the remote desktop session, the video stream being encrypted and characterized by a frame rate that is variable; reduces variability in the frame rate of the video stream by duplicating select encrypted frames of the video stream and inserting the duplicated encrypted frames into the video stream; creates packaged segments of the video stream by packing segments of the encrypted frames into containers consistent with a format compatible with a local digital rights management (DRM) client; and delivers the packaged segments to the local DRM client, the local DRM client being configured to generate control signals that cause a graphics processing unit (GPU) to present the video stream to a display of the user machine.

In some aspects, the techniques described herein relate to a system, wherein each frame of the video stream has been encrypted individually.

In some aspects, the techniques described herein relate to a system, wherein each of the containers includes a sequence of frames that spans a playback period of less than one second.

In some aspects, the techniques described herein relate to a system, wherein the remote-display protocol client inserts the duplicate encrypted frames at select locations to make the frame rate constant.

In some aspects, the techniques described herein relate to a system, further including: embedded controller of the user machine that: enters a secure mode in response to user input, the secure mode disabling communications between an operating system of the user machine and the embedded controller; while operating in the secure mode, generates a symmetric key and transmits the symmetric key to a virtual machine hosting the remote desktop session; generates an encrypted symmetric key by encrypting the symmetric key with a private device key pre-shared between the embedded controller and a GPU of the user machine; and shares the encrypted symmetric key with the GPU.

In some aspects, the techniques described herein relate to a system, wherein the embedded controller shares the encrypted symmetric key with the GPU by providing the encrypted symmetric key to an operating system of the user machine without sharing the symmetric key or the private device key with the operating system.

In some aspects, the techniques described herein relate to a system, wherein the GPU of the user machine: uses the private device key to retrieve the symmetric key from the encrypted symmetric key; decrypts the encrypted frames using the symmetric key; and renders the remote desktop session to a window of presented on a display of the user machine.

In some aspects, the techniques described herein relate to a system including: a cloud-based virtual machine that: receives a request from a user machine to initiate a remote desktop session; generates graphics content of a remote desktop session; captures a sequence of images depicting the graphics content at different instances time; and creates an encrypted video stream by using a symmetric key to encrypt each individual frame in the sequence of images independent of all remaining images in the sequence of images; and transmits the encrypted video stream to a remote-protocol desktop client executing on the user machine.

In some aspects, the techniques described herein relate to a system, wherein the cloud-based virtual machine transmits the encrypted video stream to the remote-protocol desktop client without segmenting and packaging frames of the encrypted video stream for receipt by a digital rights management (DRM) client of the user machine.

In some aspects, the techniques described herein relate to a system, wherein the cloud-based virtual machine is further configured to receive the symmetric key from an embedded controller of the user machine, the symmetric key being transmitted by the embedded controller along a secure channel that is inaccessible to an operating system of the user machine.

In some aspects, the techniques described herein relate to a system, wherein encrypted video stream is characterized by a variable frame rate and the remote-protocol desktop client on the user machine is configured to reduce variability in the frame rate by duplicating select frames of the encrypted video stream and inserting the duplicated frames into the encrypted video stream.

In some aspects, the techniques described herein relate to a system, wherein the cloud-based virtual machine executes a remote-display protocol service that communicates with the user machine to determine an encryption scheme supported by a DRM client executing on the user machine, wherein the cloud-based virtual machine encrypts each individual image in the sequence of images according to the encryption scheme.

Some implementations may comprise an article of manufacture. An article of manufacture may comprise a tangible storage medium (a memory device) to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled and/or interpreted programming language.

In some aspects, the techniques described herein relate to a method for securely providing a remote desktop session including: at a user machine, receiving a video stream including graphics content of the remote desktop session, the video stream being encrypted and characterized by a frame rate that is variable; at the user machine, reducing variability in the frame rate of the video stream by duplicating select encrypted frames of the video stream and inserting the duplicated encrypted frames into the video stream; and delivering the video stream to a local application configured to generate control signals that cause a graphics processing unit (GPU) of the user machine to render the video stream to a display of the user machine.

In some aspects, the techniques described herein relate to a method, wherein each frame of the video stream that is received at the user machine has been encrypted individually.

In some aspects, the techniques described herein relate to a method, further including: at the user machine, segmenting the encrypted frames into groups and packaging the groups as individual containers, each of the individual containers including a sequence of frames that spans a playback period of less than one second.

In some aspects, the techniques described herein relate to a method, wherein the local application is a digital rights management (DRM) client and the method further includes: determining a format of encrypted data expected by the DRM client; and at the user machine, segmenting and packaging the video stream according to the format expected by the DRM client.

In some aspects, the techniques described herein relate to a method, wherein reducing variability in the frame rate entails eliminating variability in the frame rate.

In some aspects, the techniques described herein relate to a method, further including: generating a symmetric key at an embedded controller of the user machine; based at least in part on user initiation of the remote desktop session: transmitting the symmetric key to a remote server hosting the remote desktop session; generating an encrypted symmetric key by locally encrypting the symmetric key with a private device key pre-shared between the embedded controller and a GPU of the user machine; and sharing the encrypted symmetric key with a DRM client installed on the user machine.

In some aspects, the techniques described herein relate to a method, wherein the embedded controller transmits the symmetric key to the remote server along a secure channel that is not accessible to an operating system of the user machine.

In some aspects, the techniques described herein relate to a method, further including: within the GPU of the user machine, using the private device key to retrieve the symmetric key from the encrypted symmetric key; and decrypting the encrypted frames using the symmetric key.

In some aspects, the techniques described herein relate to a system for securely providing a remote desktop session, the system including: a remote-display protocol client stored in memory of a user machine that: receives a video stream including graphics content of the remote desktop session, the video stream being encrypted and characterized by a frame rate that is variable; reduces variability in the frame rate of the video stream by duplicating select encrypted frames of the video stream and inserting the duplicated encrypted frames into the video stream; creates packaged segments of the video stream by packing segments of the encrypted frames into containers consistent with a format compatible with a local digital rights management (DRM) client; and delivers the packaged segments to the local DRM client, the local DRM client being configured to generate control signals that cause a graphics processing unit (GPU) to present the video stream to a display of the user machine.

In some aspects, the techniques described herein relate to a system, wherein each frame of the video stream has been encrypted individually.

In some aspects, the techniques described herein relate to a system, wherein each of the containers includes a sequence of frames that spans a playback period of less than one second.

In some aspects, the techniques described herein relate to a system, wherein the remote-display protocol client inserts the duplicate encrypted frames at select locations to make the frame rate constant.

In some aspects, the techniques described herein relate to a system, further including: embedded controller of the user machine that: enters a secure mode in response to user input, the secure mode disabling communications between an operating system of the user machine and the embedded controller; while operating in the secure mode, generates a symmetric key and transmits the symmetric key to a virtual machine hosting the remote desktop session; generates an encrypted symmetric key by encrypting the symmetric key with a private device key pre-shared between the embedded controller and a GPU of the user machine; and shares the encrypted symmetric key with the GPU.

In some aspects, the techniques described herein relate to a system, wherein the embedded controller shares the encrypted symmetric key with the GPU by providing the encrypted symmetric key to an operating system of the user machine without sharing the symmetric key or the private device key with the operating system.

In some aspects, the techniques described herein relate to a system, wherein the GPU of the user machine: uses the private device key to retrieve the symmetric key from the encrypted symmetric key; decrypts the encrypted frames using the symmetric key; and renders the remote desktop session to a window of presented on a display of the user machine.

In some aspects, the techniques described herein relate to a system including: a cloud-based virtual machine that: receives a request from a user machine to initiate a remote desktop session; generates graphics content of a remote desktop session; captures a sequence of images depicting the graphics content at different instances time; and creates an encrypted video stream by using a symmetric key to encrypt each individual frame in the sequence of images independent of all remaining images in the sequence of images; and transmits the encrypted video stream to a remote-protocol desktop client executing on the user machine.

In some aspects, the techniques described herein relate to a system, wherein the cloud-based virtual machine transmits the encrypted video stream to the remote-protocol desktop client without segmenting and packaging frames of the encrypted video stream for receipt by a digital rights management (DRM) client of the user machine.

In some aspects, the techniques described herein relate to a system, wherein the cloud-based virtual machine is further configured to receive the symmetric key from an embedded controller of the user machine, the symmetric key being transmitted by the embedded controller along a secure channel that is inaccessible to an operating system of the user machine.

In some aspects, the techniques described herein relate to a system, wherein encrypted video stream is characterized by a variable frame rate and the remote-protocol desktop client on the user machine is configured to reduce variability in the frame rate by duplicating select frames of the encrypted video stream and inserting the duplicated frames into the encrypted video stream.

In some aspects, the techniques described herein relate to a system, wherein the cloud-based virtual machine executes a remote-display protocol service that communicates with the user machine to determine an encryption scheme supported by a DRM client executing on the user machine, wherein the cloud-based virtual machine encrypts each individual image in the sequence of images according to the encryption scheme.

In some aspects, the techniques described herein relate to a system for securely providing a remote desktop session, the system includes a means for receiving a video stream including graphics content of the remote desktop session, the video stream being encrypted and characterized by a frame rate that is variable; a means for reducing variability in the frame rate of the video stream by duplicating select encrypted frames of the video stream and inserting the duplicated encrypted frames into the video stream; a means for creating packaged segments of the video stream by packing segments of the encrypted frames into containers consistent with a format compatible with a local digital rights management (DRM) client; and a means for delivering the packaged segments to the local DRM client, the local DRM client being configured to generate control signals that cause a graphics processing unit (GPU) to present the video stream to a display of the user machine.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

What is claimed is:

1. A method for securely providing a remote desktop session comprising:
at a user machine, receiving a video stream including graphics content of the remote desktop session, the video stream being encrypted and characterized by a frame rate that is variable;
at the user machine, reducing variability in the frame rate of the video stream by duplicating select encrypted frames of the video stream and inserting the duplicated encrypted frames into the video stream; and
delivering the video stream to a local application configured to generate control signals that cause a graphics processing unit (GPU) of the user machine to render the video stream to a display of the user machine.

2. The method of claim 1, wherein each frame of the video stream that is received at the user machine has been encrypted individually.

3. The method of claim 1, further comprising:
at the user machine, segmenting the encrypted frames into groups and packaging the groups as individual containers, each of the individual containers including a sequence of frames that spans a playback period of less than one second.

4. The method of claim 1, wherein the local application is a digital rights management (DRM) client and the method further comprises:
determining a format of encrypted data expected by the DRM client; and
at the user machine, segmenting and packaging the video stream according to the format expected by the DRM client.

5. The method of claim 1, wherein reducing variability in the frame rate entails eliminating variability in the frame rate.

6. The method of claim 1, further comprising:
generating a symmetric key at an embedded controller of the user machine;
based at least in part on user initiation of the remote desktop session:
transmitting the symmetric key to a remote server hosting the remote desktop session;
generating an encrypted symmetric key by locally encrypting the symmetric key with a private device key pre-shared between the embedded controller and a GPU of the user machine; and
sharing the encrypted symmetric key with a DRM client installed on the user machine.

7. The method of claim 6, wherein the embedded controller transmits the symmetric key to the remote server along a secure channel that is not accessible to an operating system of the user machine.

8. The method of claim 6, further comprising:
within the GPU of the user machine, using the private device key to retrieve the symmetric key from the encrypted symmetric key; and
decrypting the encrypted frames using the symmetric key.

9. A system for securely providing a remote desktop session, the system comprising:
a remote-display protocol client stored in memory of a user machine that:
receives a video stream including graphics content of the remote desktop session, the video stream being encrypted and characterized by a frame rate that is variable;
reduces variability in the frame rate of the video stream by duplicating select encrypted frames of the video stream and inserting the duplicated encrypted frames into the video stream;
creates packaged segments of the video stream by packing segments of the encrypted frames into containers consistent with a format compatible with a local digital rights management (DRM) client; and
delivers the packaged segments to the local DRM client, the local DRM client being configured to generate control signals that cause a graphics processing unit (GPU) to present the video stream to a display of the user machine.

10. The system of claim 9, wherein each frame of the video stream has been encrypted individually.

11. The system of claim 9, wherein each of the containers includes a sequence of frames that spans a playback period of less than one second.

12. The system of claim 9, wherein the remote-display protocol client inserts the duplicate encrypted frames at select locations to make the frame rate constant.

13. The system of claim 9, further comprising:
embedded controller of the user machine that:
enters a secure mode in response to user input, the secure mode disabling communications between an operating system of the user machine and the embedded controller;
while operating in the secure mode, generates a symmetric key and transmits the symmetric key to a virtual machine hosting the remote desktop session;
generates an encrypted symmetric key by encrypting the symmetric key with a private device key pre-shared between the embedded controller and a GPU of the user machine; and
shares the encrypted symmetric key with the GPU.

14. The system of claim 13, wherein the embedded controller shares the encrypted symmetric key with the GPU by providing the encrypted symmetric key to an operating system of the user machine without sharing the symmetric key or the private device key with the operating system.

15. The system of claim 14, wherein the GPU of the user machine:
uses the private device key to retrieve the symmetric key from the encrypted symmetric key;
decrypts the encrypted frames using the symmetric key; and
renders the remote desktop session to a window of presented on a display of the user machine.

16. A system comprising:
a cloud-based virtual machine that:
receives a request from a user machine to initiate a remote desktop session;
generates graphics content of a remote desktop session;
captures a sequence of images depicting the graphics content at different instances time; and
creates an encrypted video stream by using a symmetric key to encrypt each individual frame in the sequence of images independent of all remaining images in the sequence of images; and
transmits the encrypted video stream to a remote-protocol desktop client executing on the user machine.

17. The system of claim 16, wherein the cloud-based virtual machine transmits the encrypted video stream to the remote-protocol desktop client without segmenting and packaging frames of the encrypted video stream for receipt by a digital rights management (DRM) client of the user machine.

18. The system of claim 17, wherein the cloud-based virtual machine is further configured to receive the symmetric key from an embedded controller of the user machine, the symmetric key being transmitted by the embedded controller along a secure channel that is inaccessible to an operating system of the user machine.

19. The system of claim 16, wherein encrypted video stream is characterized by a variable frame rate and the remote-protocol desktop client on the user machine is configured to reduce variability in the frame rate by duplicating select frames of the encrypted video stream and inserting the duplicated frames into the encrypted video stream.

20. The system of claim 16, wherein the cloud-based virtual machine executes a remote-display protocol service that communicates with the user machine to determine an encryption scheme supported by a DRM client executing on the user machine, wherein the cloud-based virtual machine encrypts each individual image in the sequence of images according to the encryption scheme.
